(19) United States
(12) Patent Application Publication
(10) Pub. No.: US 2018/0018640 A1
(43) Pub. Date: Jan. 18, 2018

(54) GROUP INFRASTRUCTURE COMPONENTS

(71) Applicant: National ICT Australia Limited, Eveleigh, New South Wales (AU)

(72) Inventors: Bin Li, Sydney, New South Wales (AU); Yang Wang, Sydney, New South Wales (AU); Fang Chen, Sydney, New South Wales (AU); Yi Wang, Sydney, New South Wales (AU)

(73) Assignee: National ICT Australia Limited, Eveleigh, New South Wales (AU)

(21) Appl. No.: 15/546,589

(22) PCT Filed: Jan. 27, 2016
(86) PCT No.: PCT/AU2016/050039

§ 371 Date: Jul. 26, 2017

(30) Foreign Application Priority Data
Jan. 27, 2015 (AU) 2015900215

(51) Int. Cl. G06Q 10/00; G06Q 50/06; G06F 17/30

(52) U.S. Cl. CPC G06Q 10/20; G06F 17/3023; G06Q 50/06

(57) ABSTRACT

There is provided a computer-implemented method, system and software for grouping components of an infrastructure. This involves obtaining (510) historical data representing previous working events of the components of the infrastructure, the historical data being associated with a plurality of attributes of the components of the infrastructure; constructing (520), based on the historical data, a likelihood function to characterise the previous working events of the components of the infrastructure; and identifying (530), based on the likelihood function, two or more groups each comprised of one or more components of the infrastructure with reference to one or more attributes of the plurality of attributes of the components of the infrastructure.

### CROSS-REFERENCE TO RELATED APPLICATIONS

The present application claims priority from the Australian provisional application 2015900215 filed on 27 Jan. 2015 with National ICT Australia Limited being the applicant and the contents of which are incorporated herein by reference.

### TECHNICAL FIELD

The present disclosure generally relates to infrastructure health condition prediction. The present disclosure includes computer-implemented methods, software, and computer systems for grouping components of an infrastructure.

### BACKGROUND

Infrastructures play an important role in the operation of society. Infrastructures provide necessary public or private services including water supply, electric power supply, transport services, communication services, etc. Depending on the type of the service an infrastructure provides, the infrastructure may include a water supply network, a power supply network, a road and bridge network, and a telecommunication or television network. The term “infrastructure” used in the present disclosure may also include service networks of other forms, for example, a social network, a financial network. On the other hand, the infrastructure in the present disclosure may not be limited to a network for use in the operation of society, the infrastructure may also include a circuit network on a semiconductor chip that performs certain functions. Even broader, the infrastructure in the present disclosure may include a geologic system, a social system or an ecological system.

An infrastructure includes a plurality of components. For example, a water supply network may include thousands or millions of water pipes. The components in the present disclosure may be referred to as assets. The health condition of the components of infrastructure may change over time due to material degradation, environmental changes, or may be damaged by human activities. Therefore, the health condition of an infrastructure needs to be monitored and managed in a proper way.

Throughout this specification the word “comprise”, or variations such as “comprises” or “comprising”, will be understood to imply the inclusion of a stated element, integer or step, or group of elements, integers or steps, but not the exclusion of any other element, integer or step, or group of elements, integers or steps.

Any discussion of documents, acts, materials, devices, articles or the like which has been included in the present disclosure is not to be taken as an admission that any or all of these matters form part of the prior art base or were common general knowledge in the field relevant to the present disclosure as it existed before the priority date of each claim of this application.

### SUMMARY

There is provided a computer-implemented method for grouping components of an infrastructure, the method comprising:
obtaining historical data representing previous working events of the components of the infrastructure, the historical data being associated with a plurality of attributes of the components of the infrastructure;
constructing, based on the historical data, a likelihood function to characterise the previous working events of the components of the infrastructure; and
identifying, based on the likelihood function, two or more groups each comprised of one or more components of the infrastructure with reference to one or more attributes of the plurality of attributes of the components of the infrastructure.

It is an advantage of the present disclosure that the likelihood function is constructed to characterise working event behaviours of the components of the infrastructure when grouping the components. As a result, the components in the group may have similar working event behaviours, which may result in an accurate event prediction and in turn reduced operation and maintenance costs of the infrastructure.

Constructing the likelihood function may comprise constructing a gamma-Poisson distribution.

Identifying the group of one or more components may comprise constructing a Chinese Restaurant Process (CRP) with reference to an attribute of the plurality of attributes of the components to group the components with reference to the attribute.

It is an advantage of constructing the CRP that a component in a group resulting from the CRP may not be a component in another group.

Constructing the CRP may comprise constructing the CRP based on dependency of the components of the infrastructure relating to one or more attributes of the plurality of attributes.

The dependency may comprise a difference between values of the one or more attributes of the components.

The plurality of attributes may comprise one or more of location, building year, age, and size of the components.

Identifying the group of one or more components may comprise applying an inference algorithm to identify the group of one or more components.

The inference algorithm may comprise a Gibbs sampling algorithm.

Identifying the group of one or more components of the infrastructure may comprise identifying the group of one or more components of the infrastructure with reference to two or more attributes of the plurality of attributes of the components of the infrastructure.

The advantage of reference to two or more attributes of the plurality of attributes of the components of the infrastructure may lie in that the grouping of the components is performed in a multi-dimensional attribute space, the components in a group resulting from which may have similar working event behaviours in two or more attributes. Therefore, the grouping may result in a more accurate event prediction.

The method described above may further comprise determining an event indicator for one or more components in the group.

Determining the event indicator for the one or more components in the group may comprise applying a Weibull event prediction model to determine the event indicator.

Determining the event indicator for the one or more components in the group may comprise determining the event indicator based on the likelihood function.

The event indicator may comprise one or more of an event rate, a probability value and a score.

The event indicator may indicate working events that are different from the previous working events.

The method described above may further comprise causing a maintenance activity to be scheduled or conducted if the event indicator meets a threshold.

The previous working events may comprise failures of the components of the infrastructure.

The infrastructure may comprise one of the following networks:
a water pipe network;
a power supply network;
a road and bridge network; and
a telecommunication or television network.

There is provided a computer software program, including machine-readable instructions, when executed by a processor, causes the processor to perform the methods described above where appropriate.

There is provided a computer system for grouping components of an infrastructure, the computer system comprising:
a communication port to obtain historical data representing previous working events of the components of the infrastructure, the historical data being associated with a plurality of attributes of the components of the infrastructure; and
a processor comprising:
   a behaviour modelling unit to construct, based on the historical data, a likelihood function to characterise the previous working events of the components of the infrastructure; and
   a component grouping unit to identify, based on the likelihood function, two or more groups each comprised of one or more components of the infrastructure with reference to one or more attributes of the plurality of attributes of the components of the infrastructure.

The computer system may further comprise an event prediction unit to determine an event indicator for one or more components in the group.

### BRIEF DESCRIPTION OF THE DRAWINGS

Features of the present disclosure are illustrated by way of non-limiting examples, and like numerals indicate like elements, in which:

FIG. 1 illustrates an example infrastructure system in accordance with the present disclosure;

FIG. 2 illustrates example historical data of components in an infrastructure;

FIG. 3. illustrates an example graphical presentation of the components shown in FIG. 2;

FIG. 4 illustrates a first grouping result based on a heuristic grouping method given simply for reference;

FIG. 5 illustrates an example grouping method for grouping components of an infrastructure in accordance with the present disclosure;

FIG. 6 illustrates an example grouping result based on the example grouping method in accordance with the present disclosure;

FIG. 7 illustrates an example graphical presentation of the example grouping result shown in FIG. 6;

FIG. 8 illustrates a performance comparison of the heuristic grouping method with the example grouping method; and

FIG. 9 illustrates an example schematic diagram of a computing device in accordance with the present disclosure.

### BEST MODE OF THE INVENTION

System description

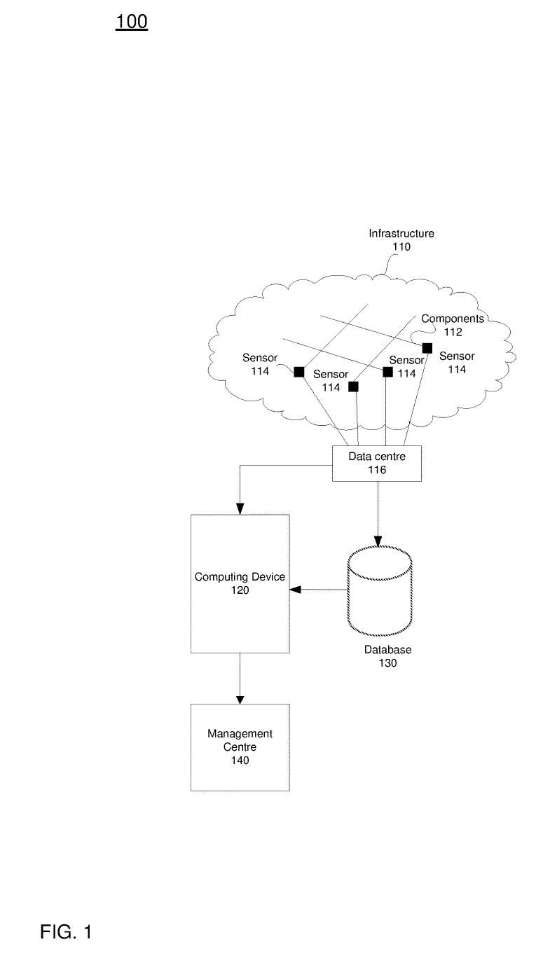

FIG. 1 illustrates an example system 100 that includes an infrastructure 110, where infrastructure is understood to be the basic physical structures and facilities (e.g. buildings, roads, power supplies) needed for the operation of a society or enterprise. An infrastructure can include a plurality of components 112.

In the example shown in FIG. 1, the infrastructure 110 is a water supply network. Accordingly, the components 112 of the infrastructure 110 include water pipes 112. It should be noted that, as described above, the infrastructure 110 may also be a power supply network, a road and bridge network, a telecommunication or television network, or other networks that offer certain services or functions, without departing from the scope of the present disclosure. The networks can be both large or small, and the method described here can apply to the whole or part of the network.

The health conditions of the components 112 may be monitored by sensors 114 that are coupled to the components 112. For example, the sensor 114 may be a pressure sensor that detects the pressure in the water pipe 112. A over high or over low pressure in the water pipe 112 may indicate the water pipe 112 fails, while a pressure in an appropriate range may indicate the water pipe 112 is in normal health conditions. The sensor 114 may also be an ultrasound sensor that detects cracks on the water pipe 112. Similarly, detection of cracks on the water pipe 112 may indicate a failure of the water pipe 112. Even more directly, the sensors 114 may be able to detect actual health conditions.

Note that the term “health condition” used in the present disclosure indicates a working status of the component 112, which may be understood by a person skilled in the art to be a normal working status, a failure, or a working status that is between a normal working status and a failure. A working event occurs if the health condition meets certain criteria. For example, if the component 112 is fully working, the working event that is occurring to this component 112 is normal, if the component 112 is not working, the working event is failure. A working event may also be defined by a health condition of the component 112 that is in a range between normal working status and failure without departing from the scope of the present disclosure.

The sensors 114 may be coupled to the components 112 mechanically, electrically, electromagnetically or in other appropriate ways to monitor health conditions of the components 112.

Data that are collected by the sensors 114 are sent from the sensor 114 to a data centre 116. The data centre 116 may compile the data into a data table that is suitable for further process by a computing device 120 or storage in a database 130. For example, a sensor reading of no pressure in a water pipe for a certain period of time may be recorded in the data table as a working event, for example, a failure. Alternatively, the water pressure of the pipe over a period of time could be made a further indicator, such as the average pressure, or number of times the pressure is higher or lower than thresholds. The compiled data are referred to as historical data in the present disclosure, which represent previous working events of the components 112 of the infrastructure 110. In other examples, the compiling of the data may be performed by the computing device 120 or the database 130 without departing from the scope of the present disclosure. In other examples, the historical data may not include data from the sensors 114. For example, the historical data may simply be pre-stored in the database 130 and the computing device 120 may simply obtain the historical data from the database 130.

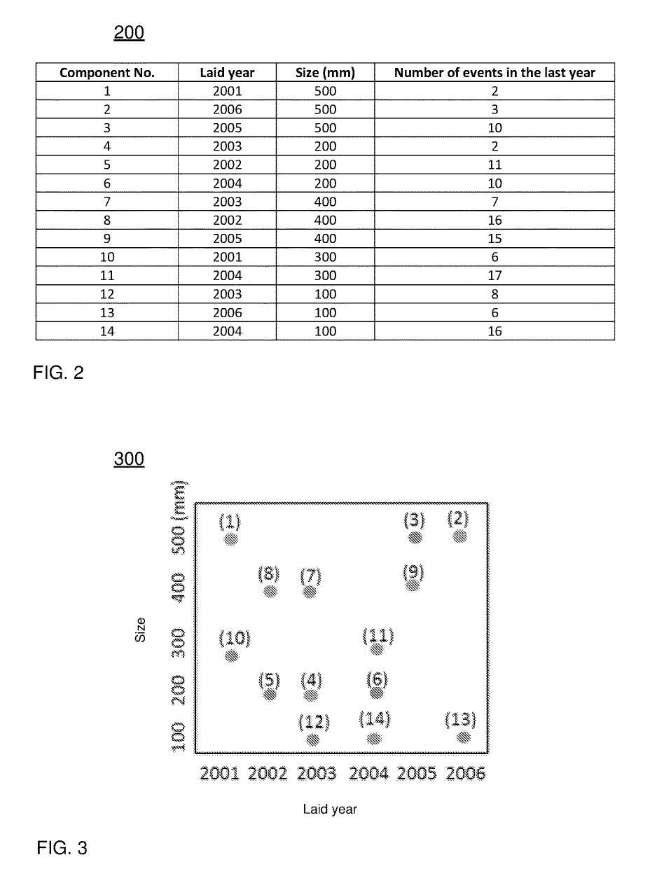

FIG. 2 illustrates example historical data of the components 112 in the infrastructure 110. The historical data are presented in a table 200 in this example.

The historical data are associated a plurality of attributes of the components 112 of the infrastructure 110, for example, laid year and size of the components 112. Specifically, the historical data may be associated with values of the attributes. The attributes of the components 112 may also be referred to as dimensions in the present disclosure especially when the present disclosure is described in the context of an attribute space.

As can be seen from the historical data shown in the table 200, the water supply network 110 includes fourteen water pipes 112 numbered 1 to 14, each of which has two attributes, laid year and size. Laid year of the water pipe 112 indicates in which year the water pipe 112 was laid and size of the water pipe 112 indicates the diameter of the water pipe 112 in millimetre (mm). The rightmost column of the table 200 indicates the number of working events that occurred to the water pipes 112 last year. For example, the water pipe No. 4 was laid in 2003 and has a diameter of 200 mm, and the working event occurred to the water pipe No. 4 twice last year.

It should be noted that although each of components No. 1 to 14 shown in table 200 represents a single component, in other examples, one or more of the components No. 1 to 14 may comprise a set of components 112 that include multiple components 112.

The components 112 shown in FIG. 2 may be presented graphically. FIG. 3 illustrates an example graphical presentation 300 of the components 112 shown in FIG. 2, which are presented in a 2-dimensional attribute space.

In FIG. 3, the components 112 are shown as dots in a coordinate system with the horizontal axis representing the laid year of the components 112 and the vertical axis representing the size of the components 112. The different grey levels of the dots represent four levels of historical working event rates. The numerals over the dots represent the numbering of the water pipe 112, which is consistent with the table 200 in FIG. 2. For example, the dot positioned at (2003, 200) indicates that the component 112 was laid in year 2003 and has a diameter of 200 mm, which is numbered 4 as indicated by the numeral over the dot.

If the components 112 have one additional attribute, for example, geographic location, the components 112 may be presented in a 3-dimensional attribute space. It should be noted that the components 112 may have further additional attributes other than laid year, size and geographic location. For example, the attributes of the components 112 may further include material, which results in more than three attributes. In this case, it may not be suitable to graphically present the components 112 in a visual attribute space with more than three dimensions.

Based on the historical data obtained from the data centre 116 or the database 130, the computing device 120 may perform analysis on the health conditions of the components 112. For example, the computing device 120 may predict a working event rate or a working event probability for each group in the next year. Particularly, if the working event is defined as a failure, the computing device 120 may predict a failure rate or a failure probability for each group in the next year.

The outcome of the analysis is sent by the computing device 120 to a computer system of a management centre 140. The outcome may be sent in an electronic message. The outcome in the electronic message may trigger the management centre 140 to execute certain management functions. For example, if the failure probability of a particular group in the message is higher than a threshold, the management centre 140 may automatically schedule a maintenance activity for the group to prevent failure of the group in the next year. Alternatively or in addition, additional data could be stored, such as to the database 130, to reflect the outcome of the analysis or displayed in a screen connected directly or indirectly to the computing device 120. As a result, the health condition of the infrastructure 110 is improved.

It should be noted that although the data centre 116, the computing device 120, the database 130 and the management centre 140 are shown as separate entities in FIG. 1, one or more of these entities can be part of other entities without departing from the scope of the present disclosure. For example, the database 130 may be a logical or a physical part of the computing device 120.

For infrastructure components working event prediction, an event prediction model may be fit to a group of components 112 which are assumed to have similar working event behaviours. Therefore, the computing device 120 may group the components 112 in analysing the health condition of the components 112.

A Heuristic Grouping Method

A heuristic grouping method is described simply for ease of reference. In the water supply network 110 shown in FIG. 1, an approach to grouping water pipes 112 may be based on domain knowledge. The water pipes 112 with similar attributes (e.g., similar laid years or sizes) may be grouped into a same group for event prediction. This is called heuristic grouping in the present disclosure.

The heuristic grouping in this example is performed with reference to two attributes, namely, laid year and size. Particularly, the values of the attribute of laid year are grouped to form two divisions based on similar laid years, namely, 2001-2003 (division 0) and 2004-2006 (division 1) on the laid year axis, while the values of the attribute of size are grouped to form two divisions based on similar sizes, 100 mm-300 mm (division 0) and 400 mm-500 mm (division 1) on the size axis. As a result, four groups of components 112 are formed.

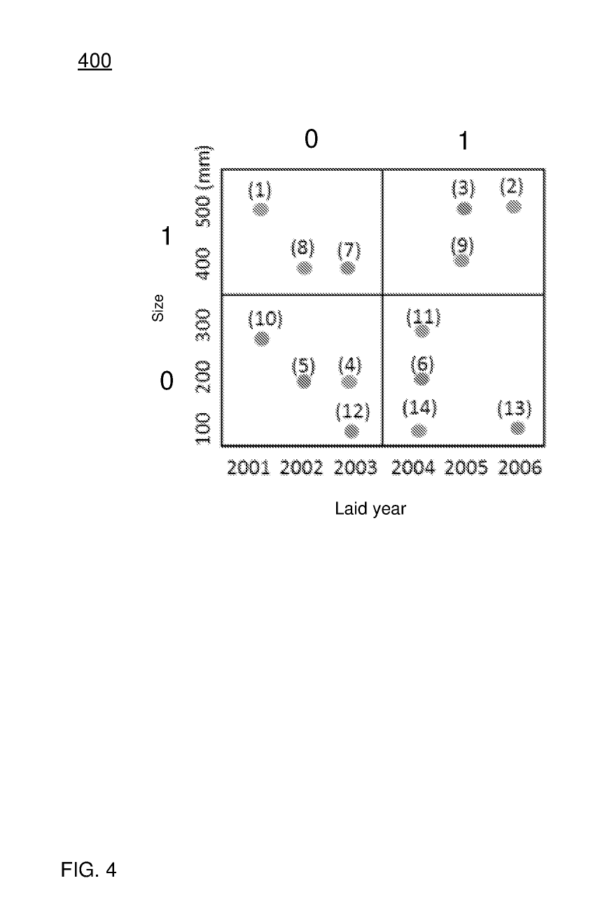

FIG. 4 illustrates a first grouping result 400 based on the heuristic grouping method given simply for reference.

The groups shown in FIG. 4 may be indicated by a group indicator, which may be indexed by division numbers with reference to the attributes. For example, the group including components No. 1, 7 and 8 may be indicated as group (0,1) since this group is in division 0 in the attribute of laid year (the first dimension) and in division 1 in the attribute of size (the second dimension). Accordingly, other groups may be indicated as group(0,0), group(1,0), group (1,1).

The components 112 in a group formed heuristically may have quite different working event behaviours in reality. For example, group (0,1) includes components No. 1, 7 and 8, but the working event of these components occurred quite different times in the last year as shown in table 200 of FIG. 2. A possible reason is that the occurrence of a working event of a component 112 depends on many known and unknown factors, which may invalidate the assumption that the components 112 with similar attributes behave similarly. It is identified here in this disclosure that it is hard to fit a statistical model to accurately characterise the working event behaviours of the components 112 in group (0,1) that is grouped together heuristically. Further, even if a statistical model is fit to group (0,1), the accuracy of an event predication made based on the model may not be satisfactory.

An Example Grouping Method

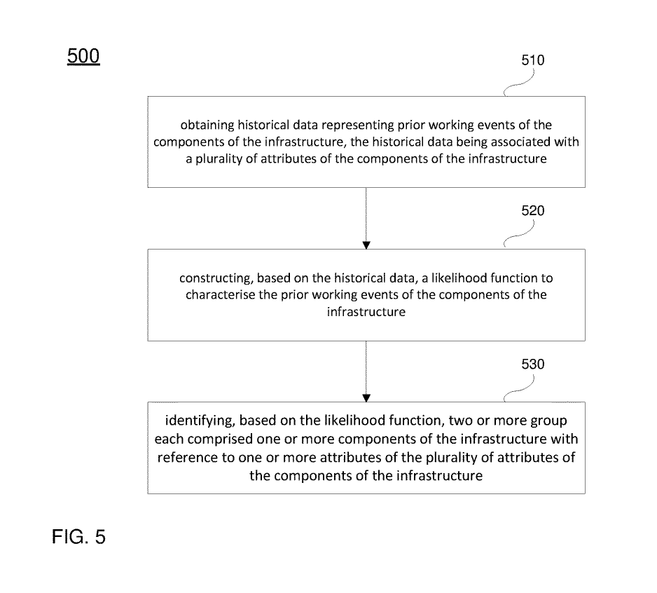

An example grouping method 500 for grouping the components 112 of the infrastructure 110 in accordance with the present disclosure is described with reference to FIG. 5.

This method 500 constructs a likelihood function based on the historical data to characterise working event behaviours of the components 112 of the infrastructure 110 and group the components 112 based on the likelihood function. The components 112 grouped together according to this method 500 have homogenous working event behaviours in an attribute space including one or more attributes of the components 112, leading to improved event prediction performance. As the likelihood function may be applied to a Bayesian nonparametric model, this grouping method is called Bayesian grouping in the present disclosure.

The attribute space in which the components 112 are grouped may be a one-dimensional or multi-dimensional attribute space. That is, the Bayesian grouping may be performed with reference to one, two or more attributes of the components 112. When the components 112 are grouped with reference to two or more attributes, that is, the grouping of the components is performed in a multi-dimensional attribute space, grouping with reference to each of the attributes may be performed to form divisions on each of the attributes. In this case, the components 112 in a group resulting from the Bayesian grouping method may have similar working event behaviours in two or more attributes. Therefore, the Bayesian grouping method may result in a more accurate event prediction.

### Obtaining the Historical Data

In this example, the historical data representing previous working events of the components 112 of the infrastructure 110, as shown in the table 200, are obtained 510 at the computing device 120. As described above, the historical data are associated with a plurality of attributes of the components 112 of the infrastructure 110, specifically, the values of the attributes. The historical data may be obtained by the computing device 120 in real time so as to conduct a real time analysis on the health condition of the components 112. In other examples, the historical data may be obtained by the computing device 120 from the database 130 regularly or on demand.

### Constructing a Likelihood Function

The computing device 120 then constructs 520, based on the historical data, a likelihood function to characterise the previous working events of the components 112 of the infrastructure 110.

θₖ_{⁽¹⁾}_{, . . . ,k}_{^{(D)}}˜G₀, for d=1, . . . , D, K^{(d)}=1, . . . , K^{(d)} (1)

x_{n˜}p(θ_{z}_{ₙ}_{⁽¹⁾}_{, . . . ,z}_{ₙ}_{^{(D)}}), for n=1, ..., N (2)

where N denotes the number of components 112, zₙ^{(d)} is the group index being the division number on the dth dimension, K^{(d)} is the current number of divisions on the d th dimension, G₀ is the base distribution of the likelihood function, and p (θ_{z}_{ₙ}_{⁽¹⁾}_{, . . . ,z}_{ₙ}_{^{(D)}}) denotes the likelihood function in the group indexed by zₙ⁽¹⁾, . . . , zₙ^{(D)} in the D -dimensional attribute space, xₙ denotes the number of previous working events of component No. n. The likelihood function may take different forms, for example, a gamma-Poisson distribution, a beta-Bernoulli distribution, etc. without departing from the scope of the present disclosure.

### Grouping the Components

The computing device 120 applies the likelihood function to a Bayesian nonparametric block model, which is a nonparametric version of stochastic block models as described in Harrison C. White, Scott A. Boorman, and Ronald L. Breiger, “Social structure from multiple networks. i. blockmodels of roles and positions”, American Journal of Sociology, pp. 730-780, 1976.

Bayesian nonparametric block models include infinite relational models (IRM) and the Mondrian process, as described in Charles Kemp, Joshua B. Tenenbaum, Thomas L. Griffiths, Takeshi Yamada, and Naonori Ueda, “Learning systems of concepts with an infinite relational model”, In Proceedings of the 21st National Conference on Artificial Intelligence, pp. 381-388, 2006, and Daniel M. Roy and Yee W. Teh, “The Mondrian process”, In Advances in Neural Information Processing Systems 21, pp. 1377-1384, 2009. In this example, the IRM is used for easy description.

The IRM is constructed through multiple independent Dirichlet process for grouping the components 112 on each dimension of the components 112, as described in Thomas S. Ferguson, “A Bayesian analysis of some nonparametric problems”, The Annals of Statistics, pp. 209-230, 1973. The Dirichlet process is a tool for partitioning data with unknown number of components in a Bayesian nonparametric manner. By marginalizing out the partition parameter, a Chinese restaurant process (Polya-urn scheme, as described in David Blackwell and James B. MacQueen, “Ferguson distribution via Polya urn schemes”, The Annals of Statistics, pp. 353-355, 1973) can be derived as the predictive distribution.

$$p ( {z}_{n} = {k}^{′} \vert {z}^{n} ) ∝ \{ \begin{matrix}{h}_{k}^{n} & if {k}^{′} = k , k = 1 , … , K \\ α & if {k}^{′} = K + 1\end{matrix} \qquad ( 3 )$$

where zₙ is a latent variable for indicating the group to which the nth component 112 belongs, K is the current number of groups, hₖ^{-,n} is the number of components 112 (excluding the nth component 112) allocated to the kth group, and a is the parameter of the Chinese restaurant process (CRP). Accordingly, the CRP may be expressed as below:

zₙ^{(d)}˜CRP(α^{(d)}), for d=1, . . . , D,n=1, . . . ,N (4)

where zₙ^{(d)} is the group index of the component No. n on the dth dimension in the attribute space and α^{(d)} is the parameter of the CRP on the dth dimension. By using the CRP, a component 112 in a group may not be a component 112 in another group.

The computing device 120 may identify 530, based on the likelihood function shown in equation (2), two or more groups each comprised of one or more components 112 of the infrastructure 110 with reference to one or more attributes of the components 112 of the infrastructure 110.

For example, based on the likelihood function shown in equation (2), a joint distribution for the variables in the CRP, zₙ^{(d)}, d=1, . . . , D, n=1, . . . ,N may be obtained:

p(x₁ . . . x_{N}, z₁⁽¹⁾ . . . z_{N}⁽¹⁾ . . . z₁^{(D)} . . . z_{N}^{(D)}|α⁽¹⁾ . . . α^{(D)}) (5)

Since λₖ_{⁽¹⁾} _{. . . k}_{^{(D)}} has been marginalized out, it does not appear in the joint distribution shown above.

By applying an inference algorithm to equation (5), z₁⁽¹⁾ . . . z_{N}⁽¹⁾ . . . z₁^{(D)} . . . z_{N}^{(D)} can be determined, in which zₙ^{(d)}, n=1 . . . N, d=1 . . . D, represent the group indices of component No. n with reference to the dth dimension in the attribute space. Therefore, the components 112 that have the same group index on each dimension belong to the same group. The inference algorithm may be based on, for example, Markov chain Monte Carlo (MCMC) approach or varitional inference (VI) approach. Particularly, a Gibbs sampling algorithm is used in this example.

A gamma distribution may be used as G₀ in equation (1) and a Poisson distribution as p(.) in equation (2). Therefore, by combining the Chinese restaurant processes shown in equation (4) and the likelihood function with conjugate priors shown in equation (2), a component grouping IRM with the gamma-Poisson distribution as the likelihood function to describe the working event behaviours of components 112 may be modelled as below:

zₙ^{(d)}˜CRP(α^{(d)}), for d=1, . . . , D, n=1, N (6-1)

λₖ_{⁽¹⁾}_{, . . . ,k}_{^{(D)}}˜Gamma(α₀, β₀), for d=1, . . . , D, k^{(d)}=1, . . . , K^{(d)} (6-2)

xₙ˜Poisson (λ_{z}_{ₙ}_{⁽¹⁾}_{, . . . ,z}_{ₙ}_{^{(D)}}), for n=1, . . . , N (6-3)

where N denotes the number of components 112, zₙ^{(d)} is the group index of the component No. n on the dth dimension in the attribute space, α^{(d)} is the parameter of the Chinese restaurant process on the dth dimension, K^{(d)} is the current number of divisions on the dth attribute dimension, α₀ and β₀ are the parameters of the gamma distribution, and Poisson (λ_{z}_{ₙ}_{⁽¹⁾}_{, . . . ,z}_{ₙ}_{^{(D)}}) denotes the likelihood function in the group indexed by zₙ⁽¹⁾, . . . , zₙ^{(D)} in the D-dimensional attribute space.

Take the historical data shown in FIG. 2 as an example, N=14 and D=2; the hyperparameters α⁽¹⁾=1.0, α⁽²⁾=2.0, α₀=9.28, β₀=1.07, equations (6-1) to (6-3) become

zₙ⁽¹⁾˜CRP(1.0), for n=1, . . . ,14 (7-1-1)

zₙ⁽²⁾˜CRP(2.0), for n=1, . . . , 14 (7-1-2)

λₖ_{⁽¹⁾}_{,k}_{⁽²⁾}˜Gamma(9.28,1.07), for k⁽¹⁾=1, . . . , K⁽¹⁾ and k⁽²⁾=1, . . . , K⁽²⁾ (7-2)

xₙ˜Poisson (λ_{z}_{ₙ}_{⁽¹⁾}_{,z}_{ₙ}_{⁽²⁾}), for n=1, . . . ,14 (7-3)

As can be seen from the above model, each component No. 1 to 14 has two group indices zₙ⁽¹⁾ and zₙ⁽²⁾, which indicate the group indices on the first dimension (“Laid year”) and second dimension (“Size”), respectively. Each group, which is formed by components 112 having the same group index on each dimension, is associated with an event behaviour parameter λₖ_{⁽¹⁾}_{,k}_{⁽²⁾}, for k⁽¹⁾=1, . . . , K⁽¹⁾ and k⁽²⁾=1, . . . , K⁽²⁾ (where K⁽¹⁾ and K⁽²⁾ denote the current number of divisions on each dimension). Each component No. 1 to 14, has a variable xₙ, indicating the number of previous working events in the last year.

In the above model constructed based on the historical data shown in FIG. 2,
zₙ⁽¹⁾ and zₙ⁽²⁾ are the outcomes of the sampling process for the model with the laid year of a component No. n being mapped to division zₙ⁽¹⁾ on the dimension of laid year, and the size of the component No. n being mapped to division zₙ⁽²⁾ on the dimension of size;
λₖ_{⁽¹⁾}_{,k}_{⁽²⁾} are unknown parameters that can be marginalized out in the posterior for sampling in that the gamma distribution shown in equation (7-2) is the conjugate prior of the Poisson distribution shown in equation (7-3);
xₙ is the number of previous working events in the last year as shown in FIG. 2 (for example, the 4th column in the table 200). As shown in the table 200, xₙ is associated with attributes of the components 112, i.e., “Laid year” and “Size”.

According to equation (5), the joint distribution of all the variables of the CRP shown in equations (7-1-1) and (7-1-2) may be obtained as below:

p(x₁ . . . x₁₄, z₁⁽¹⁾ . . . z₁₄⁽¹⁾, z₁⁽²⁾ . . . z₁₄⁽²⁾|α⁽¹⁾, α⁽²⁾, α₀, β₀) (8)

Since λₖ_{⁽¹⁾}_{,k}_{⁽²⁾} has been marginalized out, it does not appear in the joint distribution shown above.

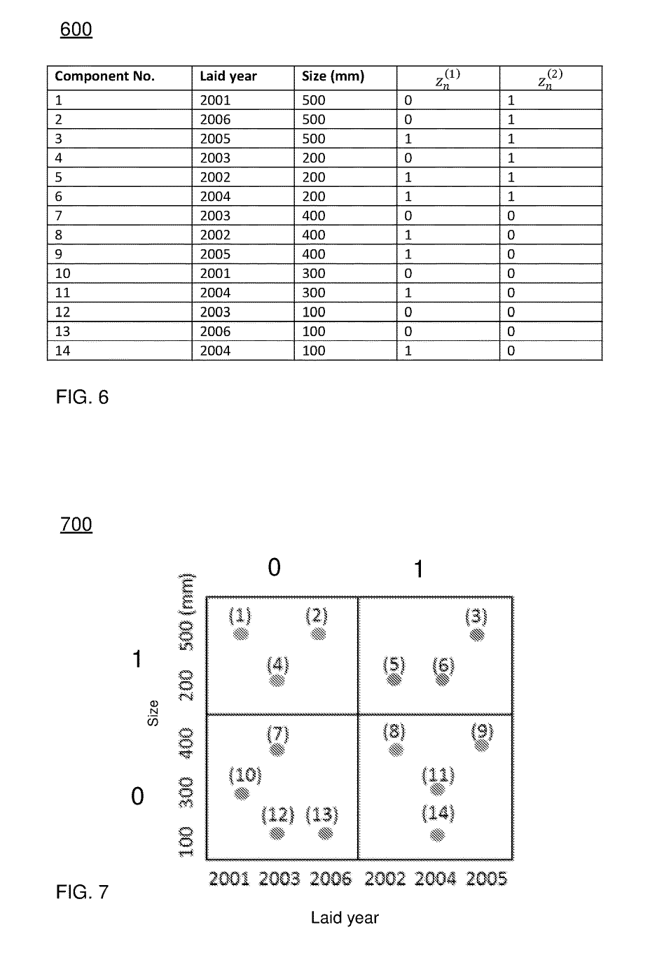

In this example, by using the Gibbs sampling algorithm described in Stuart Geman and Donald Geman, “Stochastic relaxation, Gibbs distributions, and the Bayesian restoration of images”, IEEE Transactions on Pattern Analysis and Machine Intelligence, 6(6): 721-741, 1984, z₁⁽¹⁾ . . . z₁₄⁽¹⁾, z₁⁽²⁾ . . . z₁₄⁽²⁾ can be determined, in which z₁⁽¹⁾ . . . z₁₄⁽¹⁾ represent the group indices of each component No. 1 to 14 with reference to “Laid Year”, and z₁⁽²⁾ . . . z₁₄⁽²⁾ identity the group indices of each component No. 1 to 14 with reference to “Size”, as shown in FIG. 6.

FIG. 6 illustrates an example grouping result based on the example Bayesian grouping method in accordance with the present disclosure. The example grouping result is presented in table 600.

As can be seen from the table 600, with reference to the attribute of laid year zₙ⁽¹⁾ (the group index on the first dimension), the components No. 1, 2, 4, 7, 10, 12 and 13 are in division 0 and components No. 3, 5, 6, 8, 9, 11, 14 are in division 1. On the other hand, with reference to the attribute of size zₙ⁽²⁾ (the group index on the second dimension), components No. 1, 2, 3, 4, 5, 6 are in division 1 and components No. 7, 8, 9, 10, 11, 12, 13 and 14 are in division 0.

As a result, the group including components No. 1, 2, and 4 may be represented by a group indicator being group (0,1) as the components No. 1, 2, and 4 have the same group index of “0” in laid year and the same group index of “1” in size. The group indicators for other groups may be formed in a similar way.

FIG. 7 is a graphic presentation 700 of the components No. 1 to 14 grouped according to the Bayesian grouping method as described above.

As can be seen from FIG. 7, the components 112 in the same group do not necessarily have the similar laid year or size compared to the heuristic grouping method. Specifically, the laid years or sizes of the components in the same group are not sequential. However, the working event behaviours of components 112 in the same group may be similar. For example, although the components No. 1, 2 and 4, which are in group (0,1), were laid in 2001, 2006 and 2003, they failed similar times in the last year, 2, 3 and 2 times, respectively.

An another example grouping method

In some cases, there may exist dependency among different values of one or more attributes of the components 112. The dependency may be represented by a difference between the different values of the one or more attributes of components 112. For example, the geographically neighbouring components 112 tend to have similar working event behaviours. On the geographical location dimension, neighbouring components 112 are more likely to belong to the same group. To incorporate such dependency, a distance-dependent grouping method is described as below, in which the difference between different values of an attribute is described as a distance relating to the attribute.

In this example, a distance dependent Chinese restaurant process (ddCRP) is applied, which is a non-exchangeable extension of the Chinese restaurant process, as described in David M. Blei and Peter I. Frazier, “Distance dependent Chinese restaurant processes”, The Journal of Machine Learning Research, 12:2461-2488, 2011. Therefore, instead of constructing a CRP that produces the component-to-group assignment as described above, a ddCRP is constructed based on dependency of the components 112 of the infrastructure 110 in the attributes to produce the connection indicator cₙ˜ddCRP(α, ƒ, D) as follows

$$p ( {c}_{n} = {n}^{′} \vert α , f , D ) ∝ \{ \begin{matrix}f ( {d}_{n , {n}^{′}} ) & if n \neq {n}^{′} \\ α & if n = {n}^{′}\end{matrix} \qquad ( 9 )$$

where cₙ is a variable indicating if components No. n and n′ are connected, namely, in the same group, D is a matrix indicating the distance between components 112 in a certain dimension, d_{n,n}′ denotes the distance between two components 112, and α is the parameter of the CRP. In a ddCRP, if two components No. n and n′ are reachable to each other in a particular dimension, the two components 112 are assigned to the same group on the dimension. It should be noted that the distance may not limited to a difference relating to geographic location of the components 112, the distance may include a difference between the components 112 relating to other attributes, for example, building year, age, size of the components 112 without deporting from the scope of the present disclosure.

By replacing the CRP with the ddCRP in the component grouping model shown in equations (6-1), (6-2) and (6-3), the following distance-dependent grouping model is obtained:

cₙ^{(d)}˜ddCRP(α^{(d)}, ƒ^{(d)}, D^{(d)}), for d=1, . . . , D, n=1, . . . , N (10-1)

zₙ^{(d)}=φ(cₙ^{(d)}), for d=1, . . . , D, n=1, . . . , N (10-2)

θₖ_{⁽¹⁾}_{, . . . ,k}_{^{(D)}}˜G₀, for d=1, . . . , D, k^{(d)}=1, . . . , K^{(d)} (10-3)

xₙ˜p (θ_{z}_{ₙ}_{⁽¹⁾}_{, . . . ,z}_{ₙ}_{^{(D)}}), for n=1, . . . , N (10-4)

where an additional mapping φ in equation (10-2) is used to map connection indicator cₙ^{(d)} to group index zₙ^{(d)} on the dth dimension.

The distance-dependent grouping model may incorporate different likelihood functions, for example, a gamma-Poisson distribution.

### Event Prediction

Based on the grouping result, a prediction for future working events for one or more components 112 in a group may be made. The prediction for future working events may be an event indicator of different forms. For example, the event indicator may be an event rate that indicates the possible number of events of a component 112 in the group in the next year, an event possibility, for example, a probability value, a score, or any suitable indicator that indicates a possibility of working event of a component 112 in the group in the next year. The event indicator may take other forms without departing from the scope of the present disclosure.

In one example, a Weibull event prediction model is applied to determine the event indicator as follows:

$$R ( t ) = \frac{b}{a} {( \frac{t}{a} )}^{b - 1} \qquad ( 11 )$$

where a and b are parameters of the Weibull model. These parameters are fit based on the historical data of a representative component 112 in a group or the average of historical working event data of all the components 112 in the group. In this example, the event prediction model produces an event rate of a component 112 at time t in the future. It should be noted that the event prediction model is not limited to the Weibull model shown in equation (11), other event prediction models may be applied to determine the event indicator without departing from the scope of the present disclosure. Since the components 112 in a group determined as described above have similar working event behaviours, the event prediction model may produce a more accurate prediction result for the components 112 in the group.

In another example, the likelihood function that is used to characterise the working event behaviours of the components 112 in a group may be directly used to predict the future working events. For example, the gamma-Poisson distribution in equation (6-3) or (7-3) may be used to predict the future working events of the components 112 in the group in the next year.

Particularly, for a component No. n in FIG. 6, the group indices of the component No. n are zₙ⁽¹⁾ and zₙ⁽²⁾, respectively. Therefore, the predicted event rate of the component No. n in the next year is simply E[λ_{z}_{ₙ}_{⁽¹⁾}_{,z}_{ₙ}_{⁽²⁾}], representing the expected number of working events of the component No. n in the next year, in which λ_{z}_{ₙ}_{⁽¹⁾}_{,z}_{ₙ}_{⁽²⁾} may be found in the likelihood function shown in equation (7-3).

E[λ_{z}_{ₙ}_{⁽¹⁾}_{,z}_{ₙ}_{⁽²⁾}] may be determined based on the Bayesian grouping result according to the following equation:

$$E [ {λ}_{{z}_{n}^{( 1 )} , {z}_{n}^{( 2 )}} ] = \frac{{α}_{0} + S ( {z}_{n}^{( 1 )} , {z}_{n}^{( 2 )} )}{{β}_{0} + \# ( {z}_{n}^{( 1 )} , {z}_{n}^{( 2 )} )} \qquad ( 12 )$$

where α₀=9.28, β₀=1.07 are the hyperparameters that are pre-defined for this example, #(zₙ⁽¹⁾, zₙ⁽²⁾) denotes the number of components 112 in the group indexed by (zₙ⁽¹⁾, zₙ⁽²⁾), and S(zₙ⁽¹⁾, zₙ⁽²⁾) denotes the total number of working events of the group indexed by (zₙ⁽¹⁾, zₙ⁽²⁾).

For example, for group (1,1) in FIG. 7, zₙ⁽¹⁾=1, zₙ⁽²⁾=1, n=3, 5, 6, there are three components No. 3, 5 and 6 in the group (1,1), #(zₙ⁽¹⁾, zₙ⁽²⁾)=3; and the total number of working events of this group (1,1) S(zₙ⁽¹⁾, zₙ⁽²⁾)=10+11+10=31. Therefore, the predicted event rate of the components No.3, 5, 6 is 9.8.

It should be noted that the previous working events that are used to group the components can be different from the predicted future working events indicated by the predicated event rate. For example, the previous working events represent failure events, while the predicated working events represent corrosion-level events.

As described above, the event indicator determined as above triggers a maintenance activity for the group. Particularly, the computing device 120 sends the event indictor in an electronic message to the management centre 140. If the event indicator meets a threshold, for example, the failure probability of a particular group in the message is higher than a threshold, the management centre 140 schedules a maintenance activity for the group to prevent failure of the group, such as by automatically creating an entry in an electronic calendar.

Alternatively, or in addition, the computing device 120 can also send an alert message to a mobile terminal (for example, a mobile phone) held by a technician via a short message, or an e-mail. Once the technician is aware of the message, the technician is able to conduct the maintenance activity on the components 120 in a timely manner.

In another example, the computing device 120 causes a maintenance activity to be conducted if the event indicator meets a threshold. Particularly, the computing device 120 sends an alert message to a maintenance mechanism mechanically or electrically attached to the components 120 (not shown in FIG. 1). The alert message causes the maintenance mechanism to conduct the maintenance activity on the components 120. The maintenance mechanism could in some examples be a high pressure hose or welding device.

In the description above, the maintenance activity may be part or all of the maintenance required.

### Performance Comparison

For performance comparison purpose, 140 working events are randomly generated as the test dataset for 1400 components 112 based on their true event rates. That is, there are 140 out of 1400 components 112 that would fail in the next year. The components 112 that would fail and the components 112 that would not fail are known, which is ground truth of each component 112.

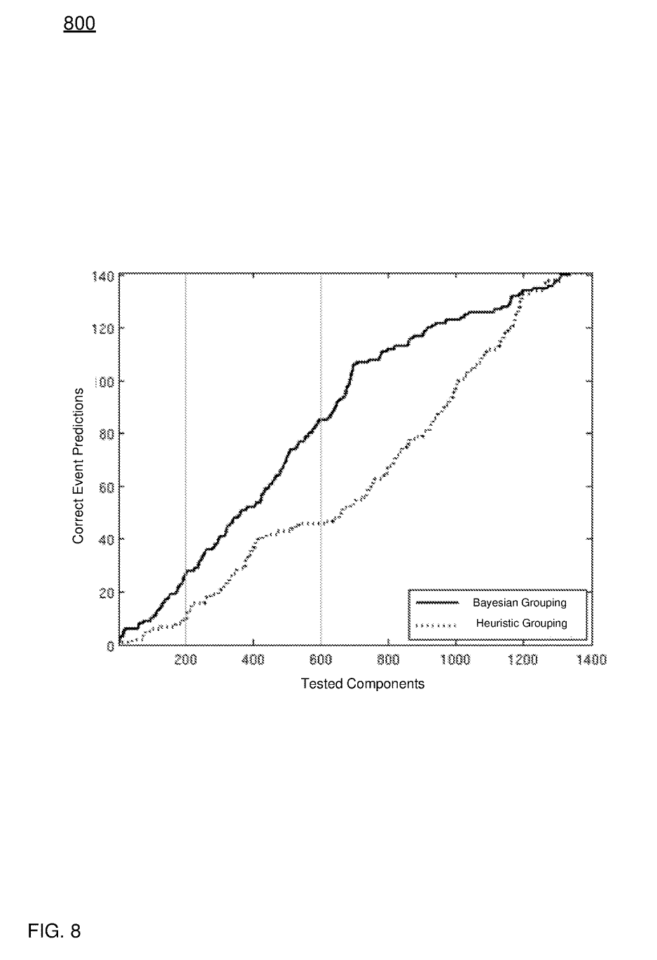

FIG. 8 illustrates a performance comparison of the heuristic grouping method with the Bayesian grouping method.

In this example, the event prediction for both grouping methods is performed based on the Poisson likelihood function. Note that the Poisson likelihood function for the heuristic grouping method may be estimated for event prediction purpose.

The horizontal axis of FIG. 8 represents the 1400 components 112 under test, and the components 112 are numbered 1 to 1400. These components 112 are ordered by their predicted event rates in descending order from left to right. The ordering of the components 112 are for presentation of the event prediction results, which does not affect the conclusion of the performance comparison.

The vertical axis represents correct event predictions for components No. 1 to m, which are the first m components 112 in the 1400 components 112 on the horizontal axis. A correct prediction means a component 112 indeed fails in the next year according to the ground truth of the component 112. It can be seen from FIG. 8 that the Bayesian grouping method results in better event predications than the heuristic grouping method does.

Take m=200 as an example, indicated as the first vertical line from the left, the Bayesian grouping method described above produces around 27 correct event predictions for components No. 1 to 200, while the heuristic grouping method only produces around 10 correct event predictions for components No. 1 to 200.

Take m=600 as another example, indicated as the second vertical line from the left, the Bayesian grouping method described above produces around 85 correct event predictions for components No. 1 to 600, while the heuristic grouping method only produces around 43 correct event predictions for components No. 1 to 600.

Note for m=1400 that both the Bayesian grouping method and the heuristic grouping method produces the same result, i.e., 140 correct event predictions. That is because all the 1400 components 112 are tested by the both methods. However, in practice, it is quite common that there are no enough resources, for example, time, financial, computing, human etc., to test each component 112 in an infrastructure 110 especially when the infrastructure 110 includes a huge amount of components 112. Therefore, more correct event predications in a smaller subset of the components 112 in the infrastructure 110 makes it possible to reduce operation and maintenance costs of the infrastructure 110.

Hardware

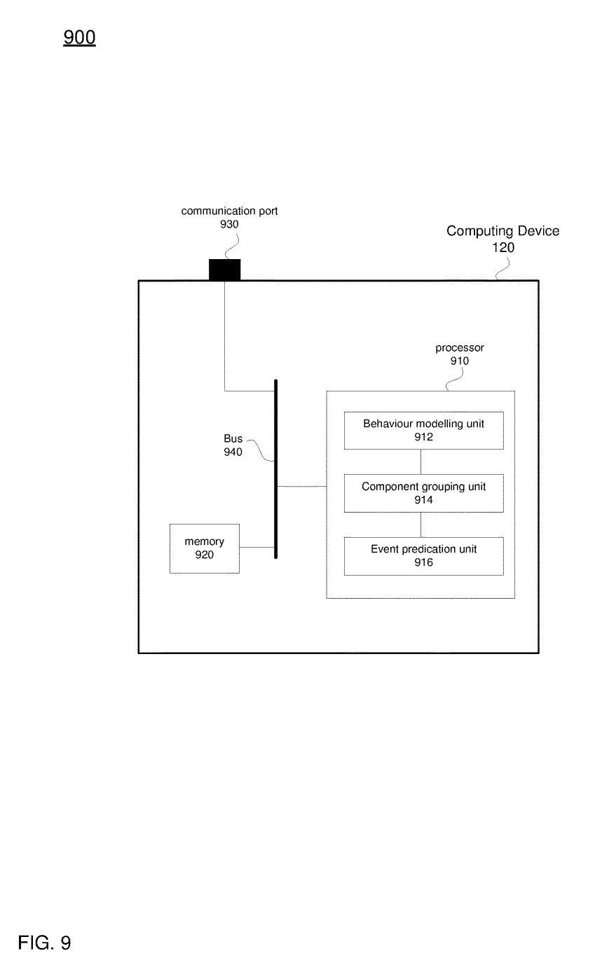

FIG. 9 illustrates an example schematic diagram 900 of the computing device 120 used to implement the example methods described above.

The computing device 120 shown in FIG. 9 includes a processor 910, a memory 920, a communication port 930 and a bus 940. The processor 910, the memory 920, the communication port 930 are connected through the bus 940 to communicate with each other.

The processor 910 performs instructions stored in the memory 920 to implement the example methods described above with reference to the computing device 120 according to the present disclosure.

The processor 910 further includes a behaviour modelling unit 912, a component grouping unit 914, and an event prediction unit 916. The separate units 912 to 916 of the processor 910 are organised in a way shown in FIG. 9 for illustration and description purpose only, which may be arranged in a different way. Specifically, one or more units in the processor 910 may be part of another unit. For example, the component grouping unit 914 may be integrated with the behaviour modelling unit 912. In another example, one or more units, particularly, the event prediction unit 916, in the processor 910 shown in FIG. 9 may be separate from the processor 910 without departing from the scope of the present disclosure.

Further, depending on the intended functions of the computing device 120, one or more units 912 to 916 may not be necessary for the computing device 120 to perform the functions. For example, the event prediction unit 916 may not be necessary for the computing device 120 to group the components 112 of the infrastructure 110.

The computing device 120 obtains 510 the historical data from the data centre 116 or the database 130 through the communication port 930. The behaviour modelling unit 912 of the processor 910 uses the historical data to construct 520 the likelihood function, for example, a gamma-Poisson distribution, to characterise the previous working events of the components 112 as described above, and the CRP or ddCRP for grouping the component 112.

The component grouping unit 914 identifies 530, based on the likelihood function, two or more groups each comprised of one or more components 112 of the infrastructure 110 with reference to one or more attributes of the components 112 of the infrastructure 110.

Particularly, the component grouping unit 914, based on the likelihood function, determines the joint distribution for the group indices in the CRP. By applying the Gibbs sampling algorithm to the joint distribution, the group indices of the components 112 are determined. As a result, the components 112 that have the same group index on each dimension belong to the same group.

Based on an event prediction model, for example, a Weibull model, or the likelihood function to characterise the working event behaviours of the components 112, the event prediction unit 916 may determine the event indicator for the components 112 in the groups identified as described above.

It should be understood that the example methods of the present disclosure might be implemented using a variety of technologies. For example, the methods described herein may be implemented by a series of computer executable instructions residing on a suitable computer readable medium. Suitable computer readable media may include volatile (e.g. RAM) and/or non-volatile (e.g. ROM, disk) memory, carrier waves and transmission media. Exemplary carrier waves may take the form of electrical, electromagnetic or optical signals conveying digital data steams along a local network or a publically accessible network such as internet.

It should also be understood that, unless specifically stated otherwise as apparent from the following discussion, it is appreciated that throughout the description, discussions utilizing terms such as “processing”, “determining”, “obtaining”, “constructing” or “identifying” or the like, refer to the action and processes of a computer system, or similar electronic computing device, that processes and transforms data represented as physical (electronic) quantities within the computer system's registers and memories into other data similarly represented as physical quantities within the computer system memories or registers or other such information storage, transmission or display devices.

1. A computer-implemented method for grouping components of an infrastructure, the method comprising:
obtaining historical data representing previous working events of the components of the infrastructure, the historical data being associated with a plurality of attributes of the components of the infrastructure;
constructing, based on the historical data, a likelihood function to characterise the previous working events of the components of the infrastructure; and
identifying, based on the likelihood function, two or more groups each comprised of one or more components of the infrastructure with reference to one or more attributes of the plurality of attributes of the components of the infrastructure.

2. The computer-implemented method according to claim 1, wherein constructing the likelihood function comprises constructing a gamma-Poisson distribution.

3. The computer-implemented method according to claim 1, wherein identifying the two or more groups of one or more components comprises constructing a Chinese Restaurant Process (CRP) with reference to an attribute of the plurality of attributes of the components to group the components with reference to the attribute.

4. The computer-implemented method according to claim 3, wherein constructing the CRP comprises constructing the CRP based on dependency of the components of the infrastructure relating to one or more attributes of the plurality of attributes.

5. The computer-implemented method according to claim 4, wherein the dependency comprises a difference between values of the one or more attributes of the components.

6. The computer-implemented method according to claim 1, wherein the plurality of attributes comprise one or more of location, building year, age, and size of the components.

7. The computer-implemented method according to claim 1, wherein identifying the two or more groups of one or more components comprises applying an inference algorithm to identify the two or more groups of one or more components.

8. The computer-implemented method according to claim 7, wherein the inference algorithm comprises a Gibbs sampling algorithm.

9. The computer-implemented method according to claim 1, wherein identifying the two or more groups group of one or more components of the infrastructure comprises identifying the two or more groups group of one or more components of the infrastructure with reference to two or more attributes of the plurality of attributes of the components of the infrastructure.

10. The computer-implemented method according to claim 1, further comprising determining an event indicator for one or more components in the group.

11. The computer-implemented method according to claim 10, wherein determining the event indicator for the one or more components in the group comprises applying a Weibull event prediction model to determine the event indicator.

12. The computer-implemented method according to claim 10, wherein determining the event indicator for the one or more components in the group comprises determining the event indicator based on the likelihood function.

13. The computer-implemented method according to claim 10, wherein the event indicator comprises one or more of an event rate, a probability value and a score.

14. The computer-implemented method according to claim 10, wherein the event indicator indicates working events that are different from the previous working events.

15. The computer-implemented method according to claim 10, further comprising causing a maintenance activity to be scheduled or conducted if the event indicator meets a threshold.

16. The computer-implemented method according to claim 1, wherein the previous working events comprise failures of the components of the infrastructure.

17. The computer- implemented method according to claim 1, wherein the infrastructure comprises a water pipe network.

18. A non-transitory computer-readable medium, including computer-executable instructions stored thereon that when executed by a processor causes the processor to perform the method of claim 1.

19. A computer system for grouping components of an infrastructure, the computer system comprising:
a communication port to obtain historical data representing previous working events of the components of the infrastructure, the historical data being associated with a plurality of attributes of the components of the infrastructure; and
a processor comprising:
a behaviour modelling unit to construct, based on the historical data, a likelihood function to characterise the previous working events of the components of the infrastructure; and
a component grouping unit to identify, based on the likelihood function, two or more groups each comprised of one or more components of the infrastructure with reference to one or more attributes of the plurality of attributes of the components of the infrastructure.

20. A computer system according to claim 19, further comprising:
an event prediction unit to determine an event indicator for one or more components in a group.
